(19) United States
(12) Patent Application Publication
(10) Pub. No.: US 2017/0351872 A1
(43) Pub. Date: Dec. 7, 2017

(54) METHOD, DEVICE, AND SYSTEM FOR SENDING AND RECEIVING INFORMATION

(71) Applicant: Beijing Xiaomi Mobile Software Co., Ltd., Beijing (CN)

(72) Inventors: Liangxiong WU, Beijing (CN); Jianquan LIU, Beijing (CN); Guangjian WANG, Beijing (CN)

(21) Appl. No.: 15/612,329

(22) Filed: Jun. 2, 2017

(30) Foreign Application Priority Data
Jun. 3, 2016 (CN) PCT/CN2016/084670

(51) Int. Cl. G06F 21/62; G06F 3/0481; G06F 21/36; G06F 21/44

(52) U.S. Cl. CPC G06F 21/6218; G06F 21/44; G06F 3/0481; G06F 21/36

(57) ABSTRACT

A method for sending information includes: acquiring an identifier of an APP, the APP being an application having an APP unlock interface; inquiring for information corresponding to the identifier of the APP, the information being information to be promoted and designated by an information promoter with respect to the APP; and sending the information to a target terminal, the information being configured to be shown in the APP unlock interface corresponding to the APP.

### CROSS-REFERENCE TO RELATED APPLICATION

This application is based upon and claims priority to PCT Patent Application No. PCT/CN2016/084670 filed on Jun. 3, 2016, the entire contents of which are incorporated herein by reference.

### TECHNICAL FIELD

The present disclosure relates to the technical field of Internet, and more particularly, to a method, a device and a system for sending and receiving information.

### BACKGROUND

An application-locking application (APP) is an APP for locking applications in a terminal. When there are a plurality of APPs in the terminal, if a user prefers to lock one of the APPs, the user may lock that APP by configuring the application-locking APP. When the user wants to use that locked APP, an APP unlock interface may be prompted. The user may use that APP normally after entering a correct unlock password in the APP unlock interface.

### SUMMARY

The present disclosure provides a method, a device and a system for sending and receiving information.

According to a first aspect of the present disclosure, there is provided a method for sending information. The method includes: acquiring an identifier of an APP, the APP being an application having an APP unlock interface; inquiring for information corresponding to the identifier of the APP, the information being information to be promoted and designated by an information promoter with respect to the APP; and sending the information to a target terminal, the information being configured to be shown in the APP unlock interface corresponding to the APP.

According to a second aspect of the present disclosure, there is provided a method for receiving information. The method includes: providing an identifier of an APP to a server, the APP being an application having an APP unlock interface; receiving information sent from the server, the information being information corresponding to the identifier of the APP; and showing the information in the APP unlock interface corresponding to the APP.

According to a third aspect of the present disclosure, there is provided a device for sending information. The device includes: a processor; and a memory for storing instructions executable by the processor, wherein the processor is configured to perform: acquiring an identifier of an APP, the APP being an application having an APP unlock interface; inquiring for information corresponding to the identifier of the APP, the information being information to be promoted and designated by an information promoter with respect to the APP; and sending the information to a target terminal, the information being configured to be shown in the APP unlock interface corresponding to the APP.

According to a fourth aspect of the present disclosure, there is provided a device for receiving information. The device includes: a processor; and a memory for storing instructions executable by the processor, wherein the processor is configured to perform: providing an identifier of an APP to a server, the APP being an application having an APP unlock interface; receiving information sent from the server, the information being information corresponding to the identifier of the APP; and showing the information in the APP unlock interface corresponding to the APP.

According to a fifth aspect of the present disclosure, there is provided a system for sending and receiving information including a server and a target terminal, the server and the target terminal being interconnected via a wired or wireless network, wherein the server includes a first device for sending information, the first device including a first processor and a first memory for storing instructions executable by the first processor, the first processor configured to perform: acquiring an identifier of an APP, the APP being an application having an APP unlock interface; inquiring for information corresponding to the identifier of the APP, the information being information to be promoted and designated by an information promoter with respect to the APP; and sending the information to a target terminal, the information being configured to be shown in the APP unlock interface corresponding to the APP, and the target terminal includes a second device for receiving information, the second device including a second processor and a second memory for storing instructions executable by the second processor, the second processor configured to perform: providing the identifier of the APP to the server; receiving the information sent from the server, the information being information corresponding to the identifier of the APP; and showing the information in the APP unlock interface corresponding to the APP.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of a system for sending information, according to an exemplary embodiment.

FIG. 2 is a flow chart of a method for sending information, according to an exemplary embodiment.

FIG. 3 is a flow chart of a method for sending information, according to another exemplary embodiment.

FIG. 4 illustrates a schematic diagram of an interface when an information promoting terminal reports information to be promoted and promoting condition to a server.

FIG. 5 is a schematic diagram of an APP unlock interface, according to an exemplary embodiment.

FIG. 6 is a schematic diagram of an APP unlock interface, according to another exemplary embodiment.

FIG. 7 is a schematic diagram of an APP unlock interface, according to another exemplary embodiment.

FIG. 8 is a schematic diagram of an APP unlock interface, according to another exemplary embodiment.

FIG. 9 is a flow chart of a method for sending information, according to another exemplary embodiment.

FIG. 10 is a block diagram of a device for sending information, according to an exemplary embodiment.

FIG. 11 is a block diagram of a device for receiving information, according to an exemplary embodiment.

FIG. 12 is a block diagram of a target terminal, according to an exemplary embodiment.

FIG. 13 is a block diagram of a server, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

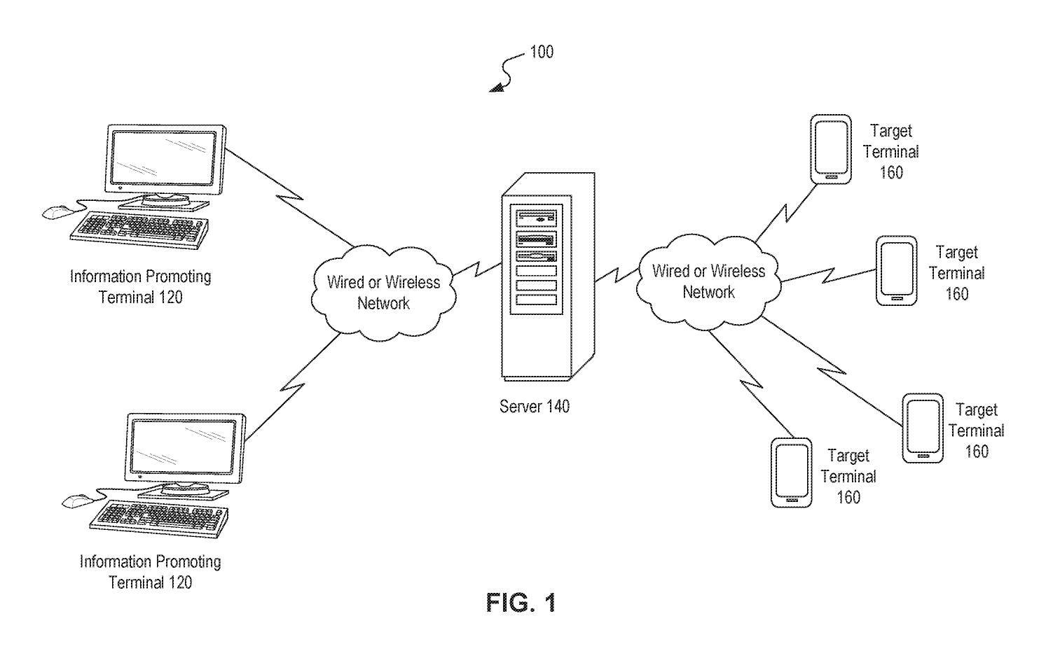

FIG. 1 is a schematic diagram of a system 100 for sending information, according to an exemplary embodiment. The system 100 includes one or more information promoting terminal 120, a server 140, and one or more target terminal 160.

The information promoting terminal 120 is a terminal used by an information promoter. The information promoting terminal 120 may be a smart phone, a tablet, a portable computer, a desktop computer, and the like. In some embodiments, a promoting APP may be running in the information promoting terminal 120. The promoting APP may be configured to upload to the server 140 information to be promoted. Alternatively, the promoting APP may be a webpage client. The information promoting terminal 120 is connected to the server 140 via a wired or wireless network.

The server 140 is configured to manage information uploaded from the information promoting terminal 120, and to send the information to the target terminal 160 according to promoting conditions configured by the information promoting terminal 120. The promoting conditions includes at least an identifier of the promoting APP. The server 140 may be one server, a plurality of servers or a cloud computing center. In some embodiments, the server 140 may be constructed by a supplier of an APP having the APP unlock interface, or may be constructed by a supplier of an application-locking APP. Optionally, the server 140 may be further connected to the target terminal 160 via a wired or wireless network.

The target terminal 160 may be a terminal including, for example, a smart phone, a tablet, a portable computer, a desktop computer, and the like. In some embodiments, the target terminal 160 is installed with an APP having an APP unlock interface, which is a native interface provided by the APP itself. Optionally, the target terminal 160 may be installed with an application-locking APP and other APPs that are not the application-locking APP, wherein the other APPs have APP unlock interfaces provided by the application-locking APP.

When an application-locking APP is used, a password is required to be set by a user. The password may be a digital password, a graphic password, a face image password or a fingerprint password. After setting the password, the user selects a second APP to be encrypted from installed APPs. After locking the second APP, when the user uses the second APP, the application-locking APP will intercept an initiating instruction of the second APP, and generate and display an APP unlock interface corresponding to the second APP. The user is required to input a correct password (i.e., the password set by the user) on the APP unlock interface to use the second APP normally.

The target terminal 160 is configured to receive information corresponding to an APP and sent by the server 140, and to display the information in an APP unlock interface of the APP.

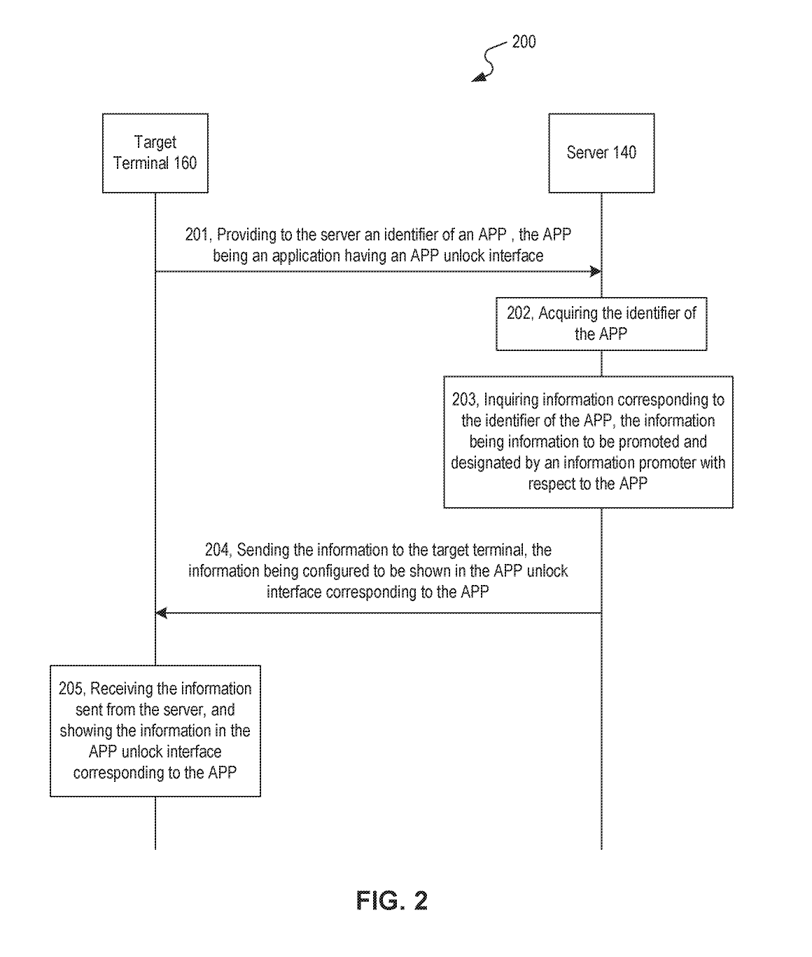

FIG. 2 illustrates a flow chart of a method 200 for sending information according to an exemplary embodiment. In the present exemplary embodiment, the method 200 will be described for the server 140 and the target terminal 160 as illustrated in FIG. 1. The method 200 includes the following steps.

In step 201, the target terminal 160 provides to the sever 140 an identifier of an APP having an APP unlock interface.

The APP unlock interface may be a native interface of the APP. Alternatively, the APP unlock interface may be an interface provided by an application-locking APP.

In step 202, the server 140 acquires the identifier of the APP.

The identifier of the APP is unique. The identifier of the APP may be represented by a name of the APP. Alternatively, the identifier of the APP may be represented by a character string. The form of the identifier of the APP is not limited in the embodiments of the present disclosure.

In step 203, the server 140 inquires information corresponding to the identifier of the APP. The information is information to be promoted and designated by an information promoter with respect to the APP.

A corresponding relationship between identifiers of APPs and information to be promoted may be stored in the server 140. Table 1 illustrates an exemplary corresponding relationship.

TABLE 1
Exemplary corresponding relationships between identifiers of
APPs and information to be promoted.

| Identifier of APP | Information to be promoted |
|---|---|
| Study APPA | Class information of training class X |
| Fitness APP B | Introduction information of healthy weight |
| | loss |
| Shopping APP C | Holiday discount information of shopping |
| | mall W |
| Music APP D | Memorial information of 100 anniversary |
| | of birth of singer M |
| . . . | . . . |

As shown in Table 1, for example, If the identifier of the APP is the “Study APP A”, the server 140 may acquire the information corresponding to the “Study APP A” as the “Class information of training class X”.

In step 204, the server 140 sends the information to the target terminal 160. The information is configured to be shown in the APP unlock interface corresponding to the APP.

In step 205, the target terminal 160 receives the information sent from the server, and shows the information in the APP unlock interface corresponding to the APP.

In the method 200 for sending information according to the present embodiment, the server 140 inquires information corresponding to the identifier of the APP. The information is information to be promoted and designated by an information promoter with respect to the APP. After the server 140 sends the information to the target terminal 160, the target terminal 160 shows the information in the APP unlock interface corresponding to the APP. It may solve the technical problem that an application-locking APP may be used only for locking and unlocking APPs, such that information may be shown in the APP unlock interface of the APP. Information relating to the APP may be provided to a user of the APP, thereby using the APP unlock interface as an effective information promoting window.

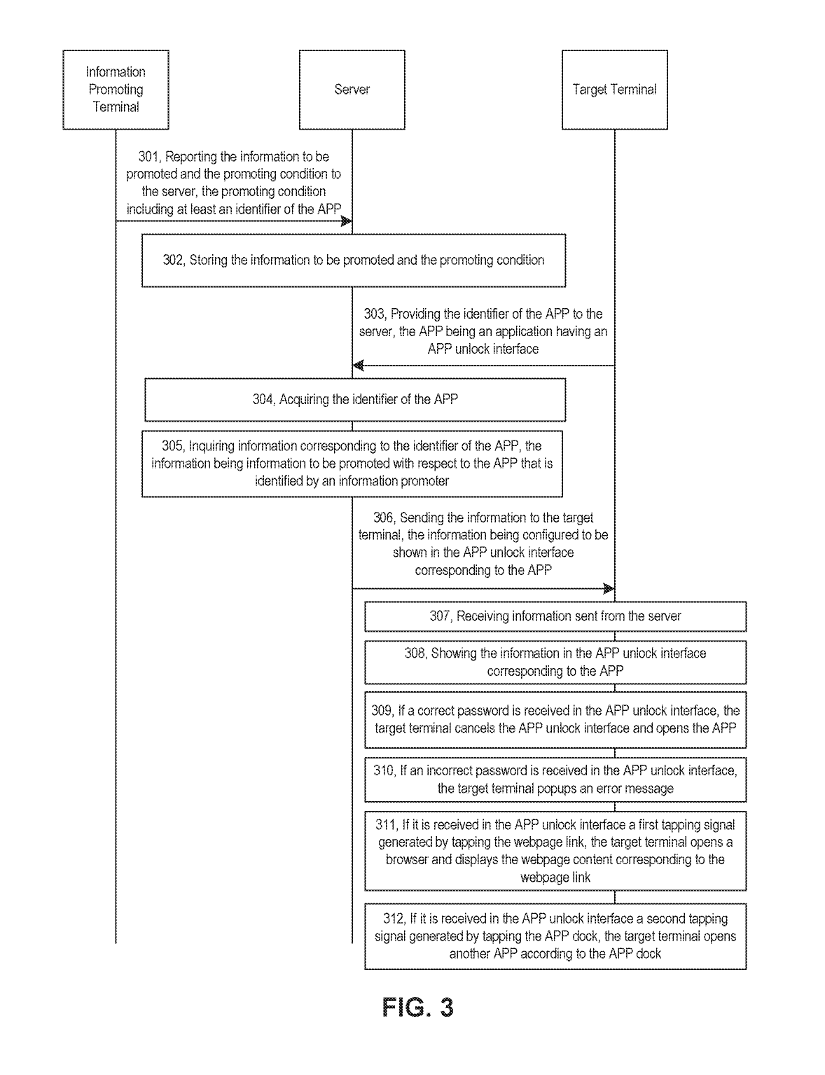

FIG. 3 illustrates a flow chart of a method 300 for sending information, according to another exemplary embodiment. In the present exemplary embodiment, for example, the method 300 will be described for the system 100—illustrated in FIG. 1. The method 300 includes the following steps.

In step 301, the information promoting terminal 120 reports to the server 140 the information to be promoted and the promoting condition. The promoting condition includes at least the identifier of the APP.

When the information promoter has a promoting requirement, the information to be promoted and the promoting condition are reported to the server 140 through the information promoting terminal 120.

The form of the information to be promoted may include, but is not limited to: images, text, videos, web links, audios, and the like.

The content of the information to be promoted may include, but is not limited to: recommended APP information, APP function introduction information, training class consulting information, sales promotion information, health management information, recommended audio and video information, movie on-show information, and the like.

The promoting condition includes at least the identifier of the APP. The APP is an APP corresponding to the information to be promoted. For example, if the information to be promoted is health management information, the corresponding APP may be a fitness APP.

In some embodiments, the promoting condition may further include at least one of age condition, sex condition, geographical location condition, educational background condition, recently browsed information condition, and recent shopping information condition. These promoting conditions may be configured as necessary conditions or optional conditions. When these promoting conditions are configured as optional conditions, a target terminal satisfying these promoting conditions may be a target terminal having a high priority, wherein a target terminal that matches more of these promoting conditions may have a higher priority.

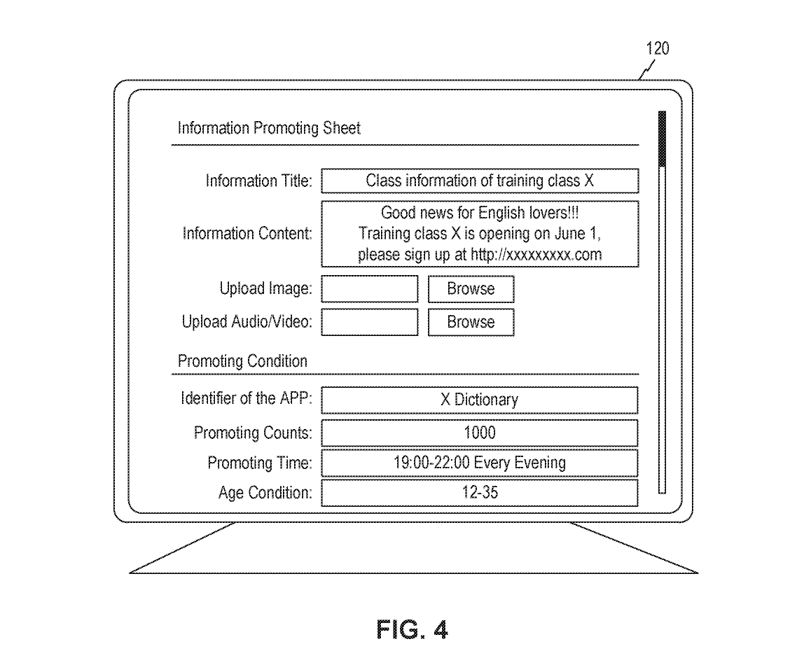

For example, FIG. 4 shows a schematic diagram of an interface of the information promoting terminal 120 reporting information to be promoted and corresponding promoting conditions. As shown in FIG. 4, information to be promoted entitled “Class information of training class X” is reported/uploaded to the server 140 via a web page client, wherein the content of the information includes “Good news for English lovers!!! Training class X is opening on June 1, please sign up at http://xxxxxxxxx.com”, and the promoting condition includes: APP “X dictionary” and age “12-35”.

Additionally, the illustrated promoting condition further includes promoting counts and promoting time. For example, the promoting counts are 1000 times, and the promoting time is 19:00-22:00 every evening.

Also, the promoting condition may further include showing information. The showing information may include, but is not limited to, at least one of the following forms: showing as a background image; showing as a background animation; showing as a background of a password input control; showing in the form of webpage link; and showing as an APP dock.

In step 302, the server 140 stores the information to be promoted and the promoting condition.

The server 140 may receive information to be promoted and corresponding promoting conditions uploaded from one or more information promoting terminals.

For example, Table 2 schematically illustrates exemplary information to be promoted and the corresponding promoting conditions stored in the server 140.

TABLE 2
Exemplary information to be promoted and corresponding promoting conditions
stored in the server.

| | | Promoting | | |
|---|---|---|---|---|
| Information | Identifier of the | counts or | | |
| title | correlated APP | promoting time | Information content | Showing form |
| Class | Study APP A | 1000 | Good news for | Showing in the |
| information | | | English lovers!!! | form of |
| of training | | | Training class X is | webpage link |
| class X | | | opening on June 1, | |
| | | | please sign up at | |
| | | | http://xxxxxxxxx.com | |
| Introduction | Fitness APP B | 2000 | Aerobics twice a | Showing in the |
| information | | | week, keeping your | form of |
| of healthy | | | perfect figure | webpage link |
| weight loss | | | | |
| Discount | Shopping APP C | 100000 | Image and webpage | The image is |
| information | | | link | shown as a |
| of shopping | | | | background |
| mall W on | | | | image, and the |
| holiday Z | | | | webpage link |
| | | | | is shown in the |
| | | | | form of |
| | | | | webpage link |
| Memorial | Music APP D | A certain day | Image and circular | The image is |
| information | | | icon | shown as a |
| of 100 | | | | background |
| anniversary | | | | image, and the |
| of birth of the | | | | circular icon is |
| singer M | | | | shown as a |
| | | | | background of |
| | | | | a password |
| | | | | input control |
| News APP | Chat APP E | 19:00-22:00 | Docking interface of | Showing as an |
| | | Every evening | the news APP | APP dock |
| . . . | . . . | . . . | . . . | . . . |

In step 303, the target terminal 160 provides to the server the identifier of the APP having the APP unlock interface.

Alternatively, the target terminal 160 may send a request for acquiring information to the server via the application-locking APP, wherein the request for acquiring information carries the identifier of the APP that is locked by the application-locking APP.

For example, if the chat APP E and the shopping APP C in a target terminal A are configured to be locked by the user, then the target terminal A sends a request for acquiring information to the server, wherein the request for acquiring information carries the identifiers of the chat APP E and the shopping APP C.

In some embodiments, the target terminal 160 sends the request for acquiring information to the server 140 every predetermined time intervals. Alternatively, the target terminal 160 sends the request for acquiring information to the server 140 at each bootup. Alternatively, the target terminal 160 sends the request for acquiring information to the server 140 when the configuration of the locked APP is changed. Optionally, the target terminal 160 may send the request for acquiring information to the server 140 upon interception of an initiating instruction for initiating the locked APP by the user.

The timing for the target terminal to send the request for acquiring information is not limited in the present embodiments, and the request for acquiring information may be sent at at least one of the above timings. Meanwhile, the count for the target terminal to send the request for acquiring information is not limited in the present embodiments. After receiving the request for acquiring information once, the server may actively send the information to the target terminal in subsequent time based on historically stored requests for acquiring information.

In step 304, the server 140 acquires the identifier of the APP.

In some embodiments, the server 140 receives the request for acquiring information sent from the application-locking APP in the target terminal 160, and acquires the identifier of the APP from the request for acquiring information.

For example, the request for acquiring information carries the identifiers of the chat APP E and the shopping APP C, and the server acquires the identifiers of the chat APP E and the shopping APP C from the request for acquiring information.

In some embodiments, the server 140 further stores a corresponding relationship between an identifier of the target terminal and the identifier of the APP.

In step 305, the server 140 inquires for the information corresponding to the identifier of the APP, wherein the information is information to be promoted and designated by an information promoter with respect to the APP.

In some embodiments, after receiving the request for acquiring the information, the server performs the step 305. Alternatively, the server performs the step 305 every predetermined time interval based on the stored corresponding relationship between the identifier of the target terminal and the identifier of the APP. The time for performing the step 305 is not limited in the present embodiments.

A corresponding relationship between the identifier of the APP and the information to be promoted is stored in the server. The server inquires for the information to be promoted in the corresponding relationship according to the identifier of the APP.

For example, the server retrieves according to the “Chat APP E” the information corresponding to the “Chat APP E” as “News APP”. For another example, the server retrieves according to the “Shopping APP C” the information corresponding to the “Shopping APP C” as “Discount information of shopping mall W on holiday Z”.

In some embodiments, after retrieving the information corresponding to the identifier of the APP, the server further detects whether the target terminal satisfies other promoting conditions including at least one of an age condition, a sex condition, a geographical location condition, an education condition, a recent browsing information condition, a recent shopping information condition, and the like.

In step 306, the server 140 sends the information to the target terminal 160, wherein the information is configured to be shown in the APP unlock interface corresponding to the APP.

Optionally, the server may send the information to the application-locking APP in the target terminal, wherein the information is configured to be shown in the APP unlock interface corresponding to the APP.

Optionally, the server may simultaneously send the corresponding relationship between the identifier of the APP and the information to the application-locking APP in the target terminal.

Optionally, the server may further send a showing form of the information in an APP interface to the target terminal.

In step 307, the target terminal 160 receives the information sent from the server 140.

In some embodiments, the application-locking APP in the target terminal receives the information sent from the server. Optionally, the application-locking APP in the target terminal may also simultaneously receive the corresponding relationship between the identifier of the APP and the information. Optionally, the application-locking APP in the target terminal may further simultaneously receives the showing form of the information. For example, Table 3 illustrates the exemplary content received by the target terminal.

TABLE 3
Exemplary content received by the target terminal.

| | Identifier of the | Information | |
|---|---|---|---|
| Information title | correlated APP | content | Showing form |
| Discount | Shopping APP C | Image and | The image is shown |
| information of | | webpage link | as a background |
| shopping mall W | | | image, and the |
| on holiday Z | | | webpage link is |
| | | | shown in the form |
| | | | of webpage link |
| News APP | Chat APP E | Docking | Showing as an |
| | | interface of | APP dock |
| | | the News APP | |

In step 308, the target terminal 160 shows the information in the APP unlock interface corresponding to the APP.

When the user starts an APP locked by the application-locking APP, the target terminal will intercept the initiating instruction corresponding to the APP. The initiating instruction may be triggered by tapping the APP icon, tapping the notification message in the taskbar, tapping a corresponding APP preview in the APP management interface, or the like. The target terminal generates and displays an APP unlock interface corresponding to the APP according to the information corresponding to the identifier of the APP.

In some embodiments, if the information includes an image and the showing form of the image is “showing as a background image”, the application-locking APP in the target terminal displays the image in the background image of the APP unlock interface.

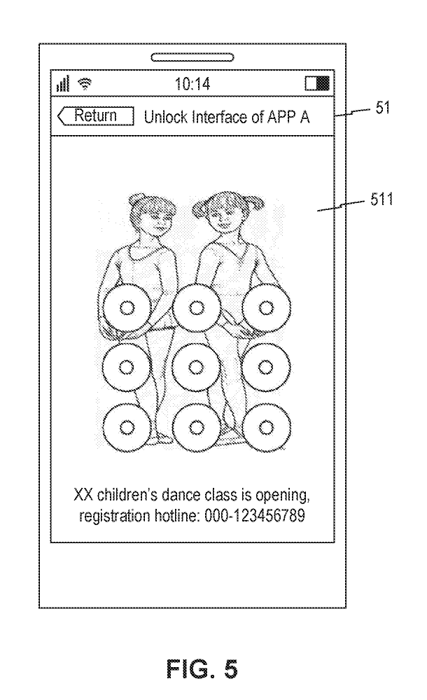

For example, FIG. 5 shows a schematic diagram of an exemplary APP unlock interface. As illustrated in FIG. 5, if the information includes the image “poster of children's dance class” 511, the image “poster of children's dance class” 511 is displayed as the background image of the APP unlock interface 51 in the APP unlock interface 51 of APP A.

If the information includes a video and the showing form of the video is “showing as a background animation”, the application-locking APP in the target terminal displays the video in the background animation of the APP unlock interface.

If the information includes a control element and the showing form of the control element is “showing as a background of a password input control”, the application-locking APP in the target terminal displays the control element in a background of the password input control in the APP unlock interface.

The password input control may be at least one of a digital password input control, a graphic password input control, a voiceprint password input control, and a fingerprint password input control.

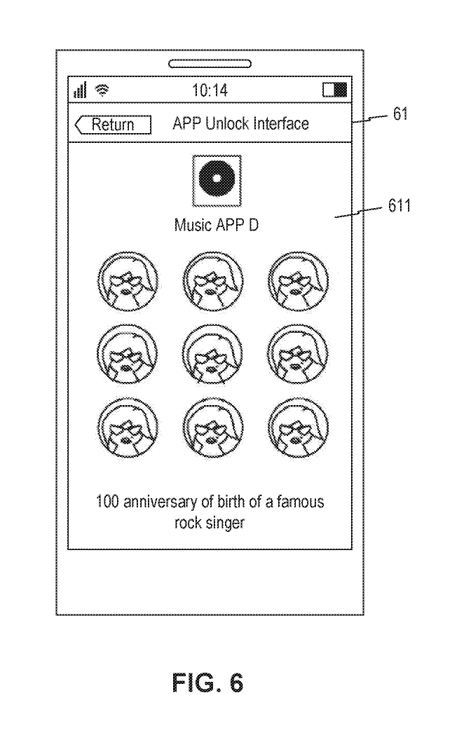

For example, FIG. 6 shows a schematic diagram of another exemplary APP unlock interface. As illustrated in FIG. 6, the password input control is a “Sudoku” graphic password input control. If the information includes a control element, e.g., a circular head portrait of a famous rock singer 611, the circular head portrait 611 is shown as the background of the “Sudoku” graphic password input control in the APP unlock interface 61 of the music APP D.

If the information includes a webpage link and the showing form of the control element is “showing in the form of webpage link”, the application-locking APP in the target terminal displays the webpage link in the form of webpage link in the APP unlock interface.

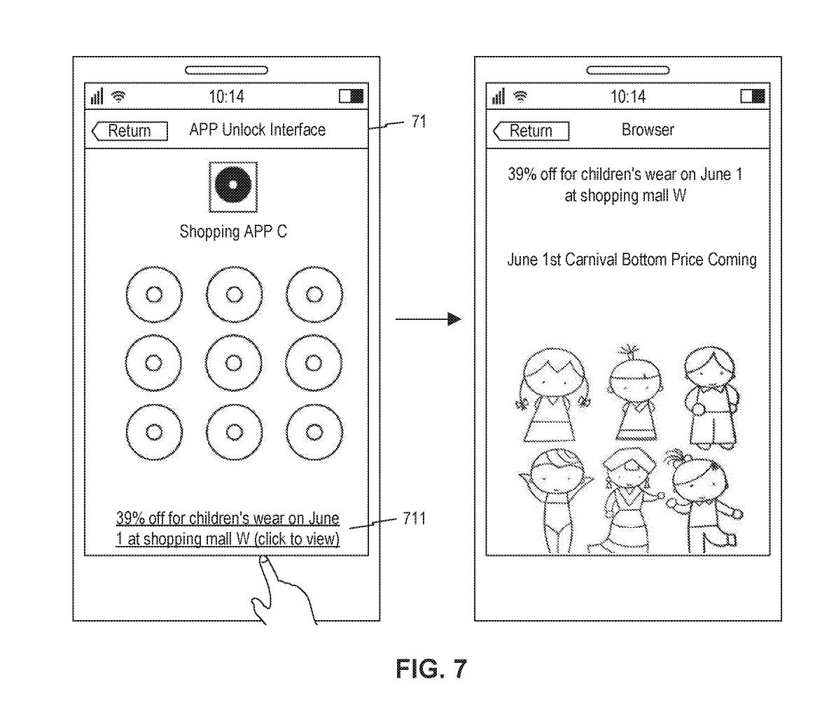

For example, FIG. 7 shows a schematic diagram of yet another exemplary APP unlock interface. As illustrated in FIG. 7, if the information includes a webpage link “39% off for children's wear on June 1 at shopping mall W” 711, the webpage link 711 is shown in the form of webpage link in the APP unlock interface 71 of the shopping APP C on the left side of FIG. 7.

When the information includes an APP docking interface for other APPs and the showing form of the APP docking interface is “showing as an APP dock”, the application-locking APP in the target terminal displays an APP dock corresponding to the APP docking interface in the APP unlock interface.

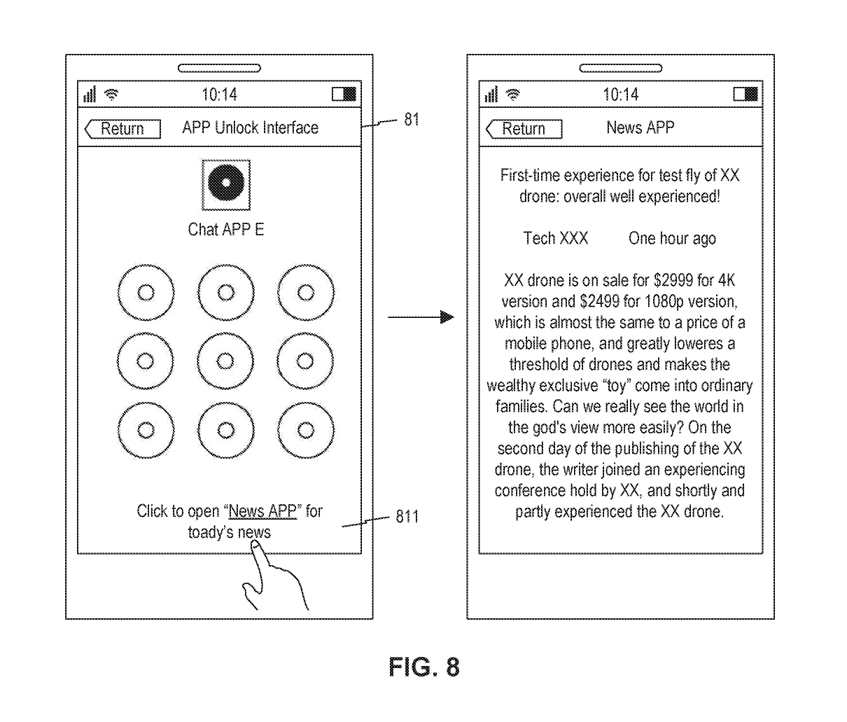

For example, FIG. 8 shows a schematic diagram of still yet another exemplary APP unlock interface. As illustrated in FIG. 8, when the information includes a docking interface for a news APP, the APP dock 811 of the news APP is displayed according to the docking interface in the APP unlock interface 81 of the chat APP E on the left side of FIG. 8.

In step 309, if a correct password is received in the APP unlock interface, the target terminal 160 cancels the APP unlock interface and opens the APP.

If the user inputs a correct password in the APP unlock interface, the application-locking APP in the target terminal cancels the display of the APP unlock interface, and starts the APP for the user's normal use.

In step 310, if an incorrect password is received in the APP unlock interface, the target terminal 160 popups an error message.

If the user inputs an incorrect password in the APP unlock interface, the application-locking APP in the target terminal generates and displays an error message. The error message is configured to indicate that the unlock password inputted by the user is incorrect, and that it is required to be inputted again or the user is refused to use the APP.

In step 311, if a first tapping signal generated by tapping the webpage link is received in the APP unlock interface, the target terminal 160 opens a browser and displays the webpage content corresponding to the webpage link.

If the user taps the webpage link in the APP unlock interface instead of inputting a password, the application-locking APP in the target terminal opens a browser and displays the webpage content corresponding to the webpage link. The browser may be a built-in browser of the application-locking APP, or may be an independent browser installed in the target terminal.

For example, referring to FIG. 7, when the webpage link “39% off for children's wear on June 1 at shopping mall W” is tapped, the application-locking APP starts the browser, and loads and displays the webpage content corresponding to the webpage link 711 by using the browser (right side of FIG. 7).

In step 312, if a second tapping signal generated by tapping the APP dock is received in the APP unlock interface, the target terminal starts another APP according to the APP dock.

If the user taps the APP dock in the APP unlock interface instead of inputting a password, the application-locking APP in the target terminal docks another APP into a running state using the docking interface corresponding to the APP dock.

For example, referring to FIG. 8, when the APP dock 811 is tapped, the application-locking APP docks the news APP into a running state according to the docking interface of the news APP (right side of FIG. 8).

In the method 300 for sending information according to the present embodiment, the server inquires information corresponding to the identifier of the APP. The information is information to be promoted and designated by an information promoter with respect to the APP. After the server sends the information to the target terminal, the target terminal shows the information in the APP unlock interface corresponding to the APP. It may solve the technical problem that an application-locking APP may be used only for locking and unlocking APPs, such that information may be shown in the APP unlock interface of the APP, and information relating to the APP may be provided to the user of the APP, thereby using the APP unlock interface as an effective information promoting window.

Since most APPs are not developed for showing information, when it is desired to show information relating to an APP, the related conventional art may need to display the information in a webpage providing an installation package of the APP, or display the information in an installation management program of the APP. In the methods for sending information according to the present embodiments, by displaying information relating to an APP in the APP unlock interface, a new channel or scheme for showing information is provided, such that the information may be sent to a user precisely and timely when the user uses the APP, thereby sending information with an efficiency and accuracy higher than the related conventional art.

According to the methods for sending information provided in the present embodiments, there are provided a plurality of showing information for showing the information in the APP unlock interface, thereby showing the information in a diversified presentation without affecting the normal use of the APP unlock interface by the user.

In some embodiments, with respect to the information sent from the information promoter, the corresponding promoting condition may further include a promoting count. In this case, after step 305, the server is required to determine whether the information has been sent more than the promoting count. If the information is not sent more than the promoting count, then step 306 is performed. If the information is sent more than the promoting count, the server will not send the information to the target terminal.

In some embodiments, with respect to the information sent from the information promoter, the corresponding promoting condition may further include promoting time. In this case, after step 305, the server is required to determine whether a current time matches the promoting time. If the current time matches the promoting time, step 306 is performed. If the current time does not match the promoting time, the server will not send the information to the target terminal.

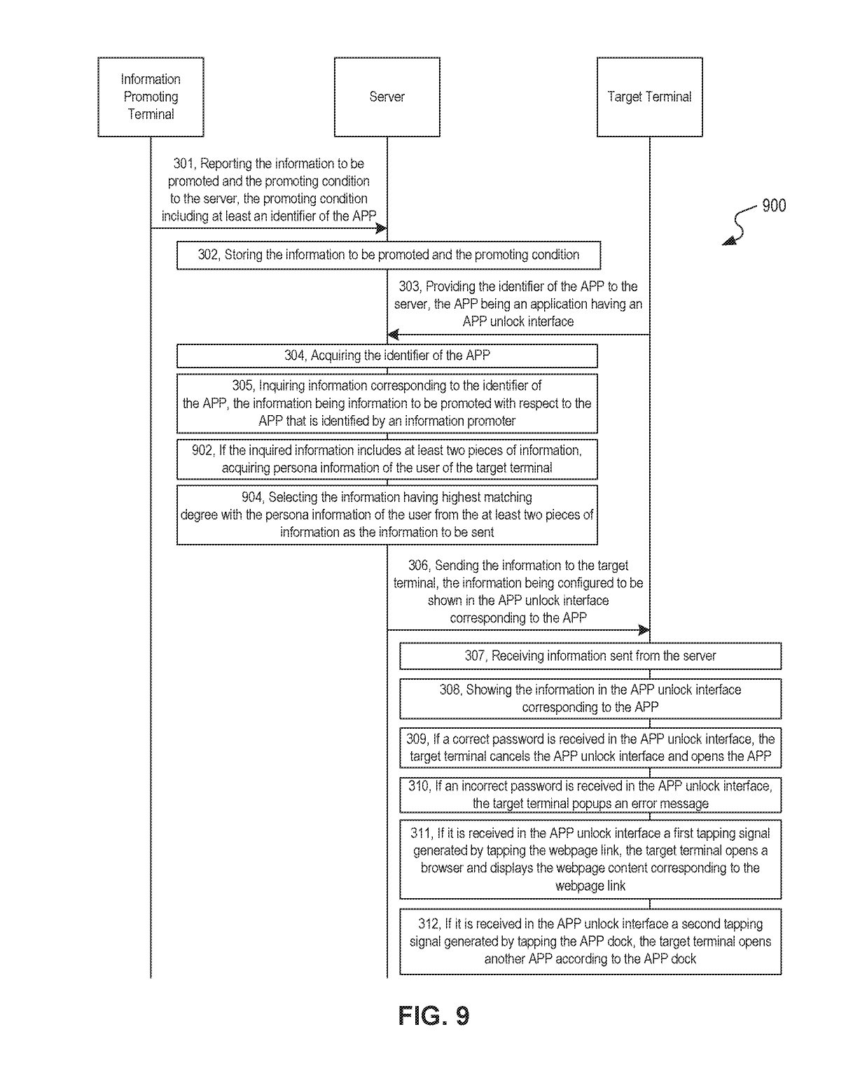

In some embodiments, with respect to a certain APP, there may be a plurality of information promoters that have provided information corresponding to the identifier of the APP. That is, in step 305, the server inquires at least two pieces of information corresponding to the identifier of the APP. In this case, the above methods for sending information, for example the method 300 may further include steps 902 and 904, as illustrated in FIG. 9 (herein referred to as a method 900). In FIG. 9, the steps except for steps 902 and 904 are the same as the steps in the method 300, the description of which is not repeated herein.

In step 902, if the inquired information in FIG. 9 includes at least two pieces of information, the server acquires personal information of the user of the target terminal.

The personal information of the user may include, but is not limited to, age, sex, geographical position, educational background, browser cache information, recently shopping information, name of recently used application, calendar information, or the like. The personal information of the user may be uploaded to the server using a predetermined program in the target terminal. The predetermined program may be the application-locking APP, and may also be another APP other than the application-locking APP. The upload procedure of the predetermined program is required to be authorized or permitted by the user.

In step 904, the server selects the information having a highest matching degree with the personal information of the user from the at least two pieces of information as the information to be sent.

In some embodiments, when the personal information of the user includes age, the information having a highest matching degree with the age is selected from the at least two pieces of information as the information to be sent.

For example, two pieces of information, i.e., information A and information B, may correspond to the APP. Information A is provided with an age condition “12-33” and information B is not provided with any age condition. If the personal information of the user includes an age “18”, the server selects the information A as the information to be sent. If the personal information includes an age “40”, the server selects the information B as the information to be sent.

In some embodiments, when the personal information of the user includes sex, the information having a highest matching degree with the sex is selected from the at least two pieces of information as the information to be sent.

For example, two pieces of information, i.e., information A and information B, may correspond to the APP. Information A is provided with a sex condition “male” and information B is provided with a sex condition “female”. If the personal information of the user includes a sex “male”, the server selects the information A as the information to be sent. If the personal information includes a sex “female”, the server selects the information B as the information to be sent.

Optionally, when the personal information of the user includes geographical position, the information having a highest matching degree with the geographical position is selected from the at least two pieces of information as the information to be sent.

For example, two pieces of information, i.e., information A and information B, may correspond to the APP. Information A is provided with a geographical position condition “Jiangsu” and information B is not provided with any geographical position condition. If the personal information of the user includes a geographical position “Nanjing”, the server selects the information A as the information to be sent since the city of Nanjing belongs to the Jiangsu province. If the personal information includes a geographical position “Beijing”, the server selects the information B as the information to be sent since the city of Beijing does not belong to the Jiangsu province.

Optionally, when the personal information of the user includes educational background, the information having a highest matching degree with the educational background is selected from the at least two pieces of information as the information to be sent.

Optionally, when the personal information of the user includes browser cache information, the information having a highest matching degree with the browser cache information is selected from the at least two pieces of information as the information to be sent.

For example, two pieces of information, i.e., information A and information B, may correspond to the APP. Information A is provided with a recently browsed information condition “browsing history relating to a dessert shop XX” and information B is provided with a recently browsed information condition “browsing history relating to a coffee shop YY”. If the personal information of the user includes a browser cache information “dessert shop XX: desert XX is on sale”, the server selects the information A as the information to be sent since the browser cache information “dessert shop XX: desert XX is on sale” belongs to the browsing history relating to the dessert shop XX. If the personal information includes a browser cache information “group purchase information of coffee shop YY”, the server selects the information B as the information to be sent since the browser cache information “group purchase information of coffee shop YY” belongs to the browsing history relating to the coffee shop YY.

Optionally, when the personal information of the user includes recent shopping information, the information having a highest matching degree with the recent shopping information is selected from the at least two pieces of information as the information to be sent.

For example, two pieces of information, i.e., information A and information B, may correspond to the APP. The information A is provided with a recent shopping condition “books” and the information B is provided with a recent shopping condition “digital products”. If the personal information of the user includes a recent shopping information “<My Life>”, the server selects the information A as the information to be sent since the recent shopping information “<My Life>” is a book. If the personal information includes a recent shopping information “SLR camera”, the server selects the information B as the information to be sent since the recent shopping information “SLR camera” belongs to a digital product.

Optionally, when the personal information of the user includes calendar information, the information having a highest matching degree with a location in the calendar information is selected from the at least two pieces of information as the information to be sent.

For example, two pieces of information, i.e., information A and information B, may correspond to the APP. The information A is provided with a geographical position condition “Jiangsu” and the information B is not provided with any geographical position condition. If the personal information of the user includes a calendar information, e.g., an airline ticket information of “from Tianjin to Nanjing”, the server selects the information A as the information to be sent since the city of Nanjing belongs to Jiangsu province.

In some embodiments, two or more of the above various personal information of the user may be combined, and a weighting mechanism may be introduced with respect to the various personal information, so as to comprehensively compute a matching degree of each piece of information with respect to the APP, and select the information having the highest matching degree as the information to be sent.

Additionally, in the case where two or more pieces of information may correspond to the APP, and if two pieces of information have the same matching degree, the server may select one piece of information as the information to be sent according to a random algorithm.

It should be noted that the steps performed by the information promoting terminal in each of the above method embodiments may be independently implemented as a method for sending information at the information promoting terminal side. The steps performed by the server may be independently implemented as a method for sending information at the server side. The steps performed by the target terminal may be independently implemented as a method for receiving information at the target terminal side.

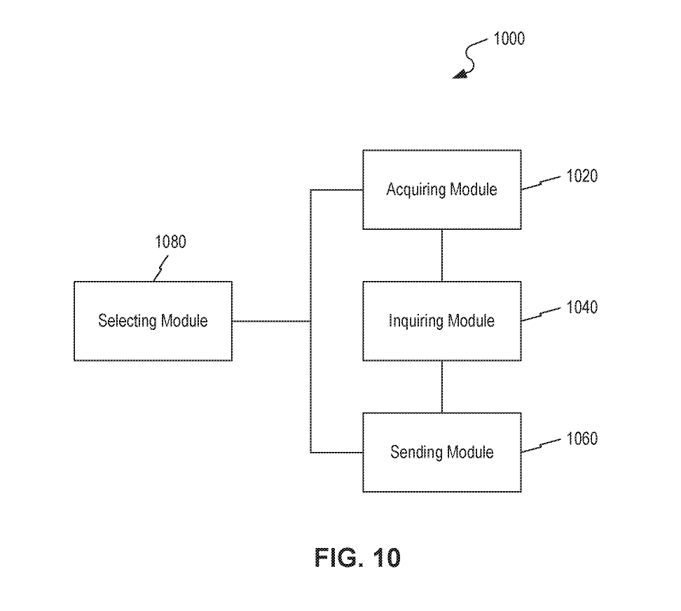

FIG. 10 is a schematic diagram of a device 1000 for sending information, according to an exemplary embodiment. The device 1000 may be implemented as a whole or a part of the server 140 of FIG. 1 using a specific hardware circuit or a combination of software and hardware. The device 1000 for sending information includes the following components.

An acquiring module 1020 is configured to acquire an identifier of an APP, and the APP is an application having an APP unlock interface.

An inquiring module 1040 is configured to inquire information corresponding to the identifier of the APP, and the information is information to be promoted and designated by an information promoter with respect to the APP.

A sending module 1060 is configured to send the information to a target terminal, and the information is configured to be shown in the APP unlock interface corresponding to the APP.

In some embodiments, the acquiring module 1020 is configured to receive a request for acquiring information sent from an application-locking APP in the target terminal, and the request for acquiring information carries an identifier of an APP locked by the application-locking APP.

In some embodiments, the sending module 1060 is configured to send the information to an application-locking APP in the target terminal, and the application-locking APP is configured to generate and show the APP unlock interface including the information when the APP is triggered.

In an embodiment, the device 1000 may further include a selecting module 1080.

The acquiring module 1020 is configured to, if the inquired information includes at least two pieces of information, acquire personal information of the user of the target terminal.

The selecting module 1080 is configured to select the information having a highest matching degree with the personal information of the user from the at least two pieces of information as the information to be sent.

In an embodiment, the selecting module 1080 is configured to, if the personal information of the user includes age, select the information having a highest matching degree with the age from the at least two pieces of information as the information to be sent.

In an embodiment, the selecting module 1080 is configured to, if the personal information of the user includes sex, select the information having a highest matching degree with the sex from the at least two pieces of information as the information to be sent.

In an embodiment, the selecting module 1080 is configured to, if the personal information of the user includes geographical position, select the information having a highest matching degree with the geographical position from the at least two pieces of information as the information to be sent.

In an embodiment, the selecting module 1080 is configured to, if the personal information of the user includes educational background, select the information having a highest matching degree with the educational background from the at least two pieces of information as the information to be sent.

In an embodiment, the selecting module 1080 is configured to, if the personal information of the user includes browser cache information, select the information having a highest matching degree with the browser cache information from the at least two pieces of information as the information to be sent;

In an embodiments, the selecting module 1080 is configured to, if the personal information of the user includes recently shopping information, select the information having a highest matching degree with the recently shopping information from the at least two pieces of information as the information to be sent.

In an embodiments, the selecting module 1080 is configured to, if the personal information of the user includes calendar information, select the information having a highest matching degree with a location in the calendar information from the at least two pieces of information as the information to be sent.

In the device 1000 for sending information according to the present embodiment, the server inquires information corresponding to the identifier of the APP, the information being information to be promoted and designated by an information promoter with respect to the APP. After the server sends the information to the target terminal, the target terminal shows the information in the APP unlock interface corresponding to the APP. It may solve the technical problem that an application-locking APP may be used only for locking and unlocking APPs, such that information may be shown in the APP unlock interface of the APP, and information relating to the APP may be provided to the user of the APP, thereby using the APP unlock interface as an effective information promoting window.

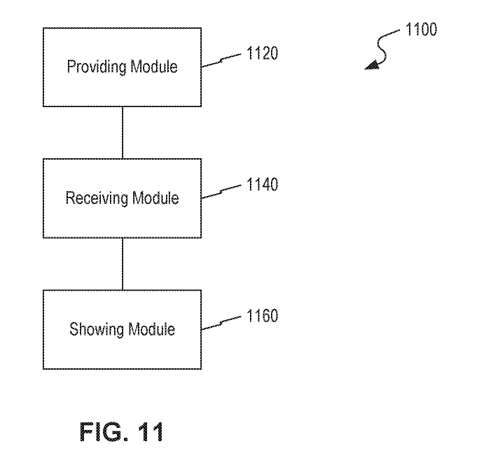

FIG. 11 illustrates a structural diagram illustrating a device 1100 for receiving information, according to an exemplary embodiment. The device 1100 for receiving information may be implemented as a whole or a part of the target terminal 160 of FIG. 1 using a specific hardware circuit or a combination of software and hardware. The device 1100 for receiving information includes the following components.

A providing module 1120 is configured to provide an identifier of an APP to a server, and the APP is an application having an APP unlock interface.

A receiving module 1140 is configured to receive information sent from the server, and the information is information corresponding to the identifier of the APP.

A showing module 1160 is configured to show the information in the APP unlock interface corresponding to the APP.

In an embodiment, the providing module 1120 is configured to send a request for acquiring information to the server via an application-locking APP, and the request for acquiring information carries the identifier of the APP locked by the application-locking APP.

In an embodiment, the receiving module 1140 is configured to receive the information sent from the server via an application-locking APP.

In an embodiment, the showing module 1160 is configured to show the information in the APP unlock interface corresponding to the APP in a predetermined showing form, and the predetermined showing form includes at least one of the following showing forms: showing as a background image; showing as a background animation; showing as a background of a password input control; showing in the form of a webpage link; and showing as an APP dock.

In the device 1100 for receiving information according to the present embodiment, the server inquires information corresponding to the identifier of the APP, the information being information to be promoted and designated by an information promoter with respect to the APP. After the server sends the information to the target terminal, the target terminal shows the information in the APP unlock interface corresponding to the APP. It may solve the technical problem that an application-locking APP may be used only for locking and unlocking APPs, such that information may be shown in the APP unlock interface of the APP, and information relating to the APP may be provided to the user of the APP, thereby using the APP unlock interface as an effective information promoting window.

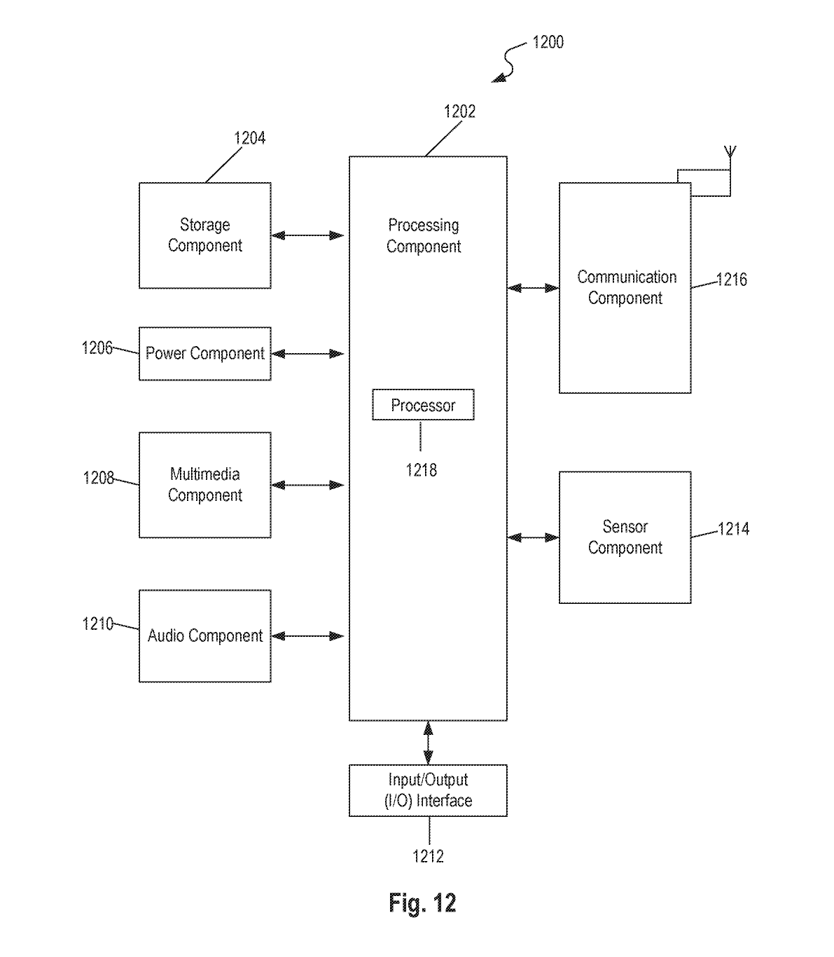

FIG. 12 is a block diagram of a target terminal 1200 according to an exemplary embodiment. For example, the target terminal 1200 may be a mobile phone, a computer, a digital broadcast terminal, a messaging device, a gaming console, a tablet, a medical device, exercise equipment, a personal digital assistant, and the like.

Referring to FIG. 12, the target terminal 1200 may include one or more of the following components: a processing component 1202, a storage component 1204, a power component 1206, a multimedia component 1208, an audio component 1210, an input/output (I/O) interface 1212, a sensor component 1214, and a communication component 1216.

The processing component 1202 typically controls overall operations of the target terminal 1200, such as the operations associated with display, telephone calls, data communications, camera operations, and recording operations. The processing component 1202 may include one or more processors 1218 to execute instructions to perform all or part of the steps in the above described methods. Moreover, the processing component 1202 may include one or more modules which facilitate the interaction between the processing component 1202 and other components. For instance, the processing component 1202 may include a multimedia module to facilitate the interaction between the multimedia component 1208 and the processing component 1202.

The storage component 1204 is configured to store various types of data to support the operation of the target terminal 1200. Examples of such data include instructions for any applications or methods operated on the target terminal 1200, contact data, phonebook data, messages, pictures, video, etc. The storage component 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the target terminal 1200. The power component 1206 may include a power management system, one or more power sources, and any other components associated with the generation, management, and distribution of power in the target terminal 1200.

The multimedia component 1208 includes a screen providing an output interface between the target terminal 1200 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and the rear camera may receive an external multimedia datum while the target terminal 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone configured to receive an external audio signal when the target terminal 1200 is in an operation mode, such as a call mode, a recording mode, and a voice recognition mode. The received audio signal may be further stored in the storage component 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the target terminal 1200. For instance, the sensor component 1214 may detect an open/closed status of the target terminal 1200, relative positioning of components, e.g., the display and the keypad, of the target terminal 1200, a change in position of the target terminal 1200 or a component of the target terminal 1200, a presence or absence of user contact with the target terminal 1200, an orientation or an acceleration/deceleration of the target terminal 1200, and a change in temperature of the target terminal 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the target terminal 1200 and other devices. The target terminal 1200 can access a wireless network based on a communication standard, such as WiFi, 2G, 3G, 4G, or a combination thereof. In one exemplary embodiment, the communication component 1216 receives a broadcast signal from an external broadcast management system via a broadcast channel or broadcast associated information. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the target terminal 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for receiving information.

In exemplary embodiments, there is also provided a non-transitory computer-readable storage medium including instructions, such as included in the storage component 1204, executable by the processor 1218 in the target terminal 1200, for performing the above-described methods for receiving information. For example, the non-transitory computer-readable storage medium may be a ROM, a RAM, a CD-ROM, a magnetic tape, a floppy disc, an optical data storage device, and the like.

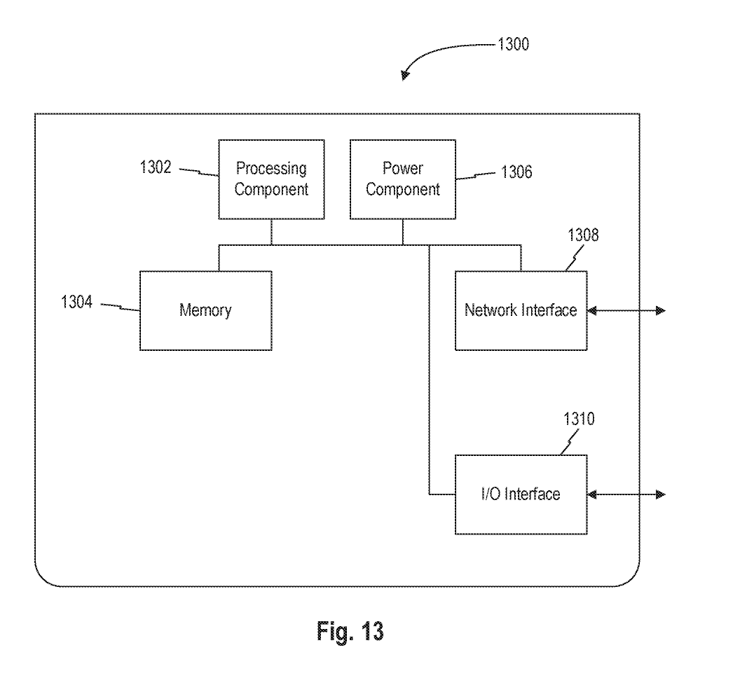

FIG. 13 is a block diagram of a server 1300 according to another exemplary embodiment. For example, the server 1300 may be provided as a network side apparatus. Referring to FIG. 13, the server 1300 may include one or more of a processing component 1302 that further includes one or more processors, and memory resources represented by a memory 1304 for storing instructions executable by the processing component 1302, such as application programs. The application programs stored in the memory 1304 may include one or more modules each corresponding to a set of instructions. Further, the processing component 1302 is configured to execute the instructions to perform the above described methods for sending information.

The server 1300 may also include a power component 1306 configured to perform power management of the server 1300, wired or wireless network interface(s) 1308 configured to connect the server 1300 to a network, and an input/output (I/O) interface 1310. The server 1300 may operate based on an operating system stored in the memory 1304, such as Windows Server™, Mac OS X™, Unix™, Linux™, FreeBSD™, or the like.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for sending information, comprising:
acquiring an identifier of an APP, the APP being an application having an APP unlock interface;
inquiring for information corresponding to the identifier of the APP, the information being information to be promoted and designated by an information promoter with respect to the APP; and
sending the information to a target terminal, the information being configured to be shown in the APP unlock interface corresponding to the APP.

2. The method according to claim 1, wherein the acquiring an identifier of an APP comprises:
receiving a request for acquiring information sent from an application-locking APP in the target terminal, the request for acquiring information carrying the identifier of the APP locked by the application-locking APP.

3. The method according to claim 1, wherein the sending the information to a target terminal comprises:
sending the information to an application-locking APP in the target terminal, the application-locking APP being configured to generate and show the APP unlock interface comprising the information when the APP is triggered.

4. The method according to claim 1, further comprising:
if the inquired information comprises at least two pieces of information, acquiring personal information of a user of the target terminal; and
selecting the information having a highest matching degree with the personal information of the user from the at least two pieces of information as the information to be sent to the target terminal.

5. The method according to claim 4, wherein the selecting the information having a highest matching degree with the personal information of the user from the at least two pieces of information as the information to be sent to the target terminal comprises at least one of:
if the personal information of the user comprises age, selecting the information having the highest matching degree with the age from the at least two pieces of information as the information to be sent to the target terminal;
if the personal information of the user comprises sex, selecting the information having the highest matching degree with the sex from the at least two pieces of information as the information to be sent to the target terminal;
if the personal information of the user comprises geographical position, selecting the information the having highest matching degree with the geographical position from the at least two pieces of information as the information to be sent to the target terminal;
if the personal information of the user comprises educational background, selecting the information having the highest matching degree with the educational background from the at least two pieces of information as the information to be sent to the target terminal;
if the personal information of the user comprises browser cache information, selecting the information having the highest matching degree with the browser cache information from the at least two pieces of information as the information to be sent to the target terminal;
if the personal information of the user comprises recently shopping information, selecting the information having the highest matching degree with the recently shopping information from the at least two pieces of information as the information to be sent to the target terminal; and
if the personal information of the user comprises calendar information, selecting the information having the highest matching degree with a location in the calendar information from the at least two pieces of information as the information to be sent to the target terminal.

6. A method for receiving information, comprising:
providing an identifier of an APP to a server, the APP being an application having an APP unlock interface;
receiving information sent from the server, the information being information corresponding to the identifier of the APP; and
showing the information in the APP unlock interface corresponding to the APP.

7. The method according to claim 6, wherein the providing an identifier of an APP to a server comprises:
sending a request for acquiring information to the server via an application-locking APP, the request for acquiring information carrying the identifier of the APP locked by the application-locking APP.

8. The method according to claim 6, wherein the receiving information sent from the server comprises:
receiving the information sent from the server via an application-locking APP.

9. The method according to claim 6, wherein the showing the information in the APP unlock interface corresponding to the APP comprises:
showing the information in the APP unlock interface corresponding to the APP in a predetermined showing form, the predetermined showing form comprising at least one of the following showing forms: showing as a background image; showing as a background animation; showing as a background of a password input control; showing in the form of webpage link; and showing as an APP dock.

10. A device for sending information comprising:
a processor; and
a memory for storing instructions executable by the processor,
wherein the processor is configured to perform:
acquiring an identifier of an APP, the APP being an application having an APP unlock interface;
inquiring for information corresponding to the identifier of the APP, the information being information to be promoted and designated by an information promoter with respect to the APP; and
sending the information to a target terminal, the information being configured to be shown in the APP unlock interface corresponding to the APP.

11. The device according to claim 10, wherein the acquiring an identifier of an APP comprises:
receiving a request for acquiring information sent from an application-locking APP in the target terminal, the request for acquiring information carrying the identifier of the APP locked by the application-locking APP.

12. The device according to claim 10, wherein the sending the information to a target terminal comprises:
sending the information to an application-locking APP in the target terminal, the application-locking APP being configured to generate and show the APP unlock interface comprising the information when the APP is triggered.

13. The device according to claim 10, wherein the processor is further configured to perform:
if the inquired information comprises at least two pieces of information, acquiring personal information of a user of the target terminal; and
selecting the information having a highest matching degree with the personal information of the user from the at least two pieces of information as the information to be sent to the target terminal.

14. The device according to claim 13, wherein the selecting the information having a highest matching degree with the personal information of the user from the at least two pieces of information as the information to be sent comprises at least one of:
if the personal information of the user comprises age, selecting the information having the highest matching degree with the age from the at least two pieces of information as the information to be sent to the target terminal;
if the personal information of the user comprises sex, selecting the information having the highest matching degree with the sex from the at least two pieces of information as the information to be sent to the target terminal;
if the personal information of the user comprises geographical position, selecting the information the having highest matching degree with the geographical position from the at least two pieces of information as the information to be sent to the target terminal;
if the personal information of the user comprises educational background, selecting the information having the highest matching degree with the educational background from the at least two pieces of information as the information to be sent to the target terminal;
if the personal information of the user comprises browser cache information, selecting the information having the highest matching degree with the browser cache information from the at least two pieces of information as the information to be sent to the target terminal;
if the personal information of the user comprises recently shopping information, selecting the information having the highest matching degree with the recently shopping information from the at least two pieces of information as the information to be sent to the target terminal; and
if the personal information of the user comprises calendar information, selecting the information having the highest matching degree with a location in the calendar information from the at least two pieces of information as the information to be sent to the target terminal.

15. A device for receiving information, comprising:
a processor; and
a memory for storing instructions executable by the processor,
wherein the processor is configured to perform:
providing an identifier of an APP to a server, the APP being an application having an APP unlock interface;
receiving information sent from the server, the information being information corresponding to the identifier of the APP; and
showing the information in the APP unlock interface corresponding to the APP.

16. The device according to claim 15, wherein the providing an identifier of an APP to a server comprises:
sending a request for acquiring information to the server via an application-locking APP, the request for acquiring information carrying the identifier of the APP locked by the application-locking APP.

17. The device according to claim 15, wherein the receiving information sent from the server comprises:
receiving the information sent from the server via an application-locking APP.

18. The device according to claim 15, wherein the showing the information in the APP unlock interface corresponding to the APP comprises:
showing the information in the APP unlock interface corresponding to the APP in a predetermined showing form, the predetermined showing form comprising at least one of the following showing forms: showing as a background image; showing as a background animation; showing as a background of a password input control; showing in the form of webpage link; and showing as an APP dock.

19. A system for sending and receiving information comprising a server and a target terminal, the server and the target terminal being interconnected via a wired or wireless network,
wherein:
the server comprises a first device for sending information, the first device including a first processor and a first memory for storing instructions executable by the first processor, the first processor configured to perform:
acquiring an identifier of an APP, the APP being an application having an APP unlock interface;
inquiring for information corresponding to the identifier of the APP, the information being information to be promoted and designated by an information promoter with respect to the APP; and
sending the information to a target terminal, the information being configured to be shown in the APP unlock interface corresponding to the APP, and
the target terminal comprises a second device for receiving information, the second device including a second processor and a second memory for storing instructions executable by the second processor, the second processor configured to perform:
providing the identifier of the APP to the server;
receiving the information sent from the server, the information being information corresponding to the identifier of the APP; and
showing the information in the APP unlock interface corresponding to the APP.
